(19) United States
(12) Patent Application Publication
(10) Pub. No.: US 2023/0110618 A1
(43) Pub. Date: Apr. 13, 2023

(54) SCORCH PROTECTED ORANIC PEROXIDE FORMULATIONS

(71) Applicant: Arkema Inc., King of Prussia, PA (US)

(72) Inventor: Leonard H. PALYS, King of Prussia, PA (US)

(21) Appl. No.: 17/914,385

(22) PCT Filed: Apr. 8, 2021
(86) PCT No.: PCT/US2021/026428

§ 371 Date: Sep. 26, 2022

Related U.S. Application Data
(60) Provisional application No. 63/007,457, filed on Apr. 9, 2020.

(51) Int. Cl. C08K 5/14; C08K 5/08

(52) U.S. Cl. CPC C08K 5/14; C08K 5/08

(57) ABSTRACT

Embodiments of organic peroxide formulations provide longer scorch time protection and require fewer additives. The peroxide formulations may include, for example, at least one organic peroxide, and at least one scorch retardant additive selected from the group consisting of vitamin K1 (phlloquinone), K2 (menaquinone), K3 (menadione), olive leaf oil (oleuropein), and mixtures thereof.

### FIELD OF THE INVENTION

The present invention relates to formulations and methods for creating peroxide formulations with increased scorch protection, and products made by those methods.

### BACKGROUND OF THE INVENTION

Organic peroxides are the curative of choice to crosslink thermoplastic polymers, elastomers and their mixtures, when the finished goods must meet stringent mechanical and physical property specifications. Using organic peroxide for crosslinking provides the needed retention of various desirable physical properties upon thermal aging, such as low percent compression set (low permanent deformation under heat and pressure) compared with uncrosslinked thermoplastics and/or sulfur cured elastomers.

The solid polymers, elastomers or rubbers are mechanically mixed under heat and shear to incorporate the organic peroxides, reinforcing fillers, oils, antioxidants, mold release agents and other ingredients. “Scorch” is premature or unwanted crosslinking or modification of polymers, elastomers or rubbers that occurs during mixing or processing. When scorch occurs, problems result including poor dispersion of the ingredients, elevated rubber compound viscosity, incomplete mold filling, and creation of defective parts and scrap. “Scorch time” is the safe processing time at a particular temperature profile before the onset of undesirable increase in compound viscosity. The time from the addition of free radical precursor up to incipient crosslinking (scorch time) is dependent on the peroxide thermal decomposition rate (expressed as the half-life period) of the free radical initiators used as crosslinking agents.

The longer the safe processing time (scorch time) before the onset of scorch, the more beneficial it is for the various rubber mixing, compounding or processing operations, such as two roll milling, Banbury-type internal mixing, or extrusion. Scorch begins when the time and temperature relationship results in the start of appreciable decomposition of the free radical initiator. If peroxide decomposition occurs too soon, gel particles in the mass of polymer forms and increases rubber compound viscosity, thereby producing non-homogeneity in the final product. Excessive scorch significantly reduces the flow properties the polymer, rubber or elastomer so processing into useable parts becomes very difficult or impossible, resulting in scrap or even loss of the entire batch.

There have been several attempts to extend scorch time. U.S. Pat. No. 5,245,084 discloses use of organic peroxides suitable for crosslinking thermoplastics and elastomers in combination with a specific group of hydroquinones and a crosslinkage promoter selected from crosslinkage promoters normally used in these applications. U.S. Pat. No. 6,197,231 teaches the use of a combination of free radical initiators (either organic peroxides or a specific class of azo initiators) in combination with hydroquinones, crosslinkage promoters and known sulfur releasing sulfur accelerators for extending scorch time without adverse effects on cure time or cure density for thermoplastics, elastomers and their mixtures.

However, none of these documents describe a scorch protected peroxide that is suitable for use for applications that are intended for use in polymers and rubber to create products suitable for use in indirect food contact, skin contact or medical applications.

### SUMMARY OF THE INVENTION

Embodiments of the present invention relate to organic peroxide formulations comprising scorch retarders derived or derivable from natural sources that may be suitable for use in products that may comply with various governmental indirect food contact; FDA skin contact or medical applications; or NSF® (National Sanitation Foundation) guidelines. Embodiments of the invention also relate to crosslinkable polymer compositions (including elastomers), processes for curing the polymers, and products made by such processes.

The scorch retarders disclosed herein are derived or derivable from natural sources. They may be selected from the following sources:

thyme plant such as thymol (2-isopropyl-5-methylphenol, IPMP);

kale, collard greens, and spinach such as Vitamin K1 (phytonadione or phylloquinone), Vitamin K2 (menaquinone), Vitamin K3 (menadione), Vitamin K2 MK-4 (menatetrenone), Vitamin K2 MK-7, Vitamin K2 MK-14, and Vitamin K2 menatetrenone epoxide;

rhubarb, Chinese rhubarb, and lichen such as emodin (6-methyl-1,3,8-trihydroxyanthraquinone), parietin or physcion (1,8-dihydroxy-3-methoxy-6-methyl-anthracene-9,10-dione), and rhein (4,5-dihydroxy-9,10-dioxoanthracene-2-carboxylic acid);

aloe vera such as aloe-emodin (1,8-dihydroxy-3-(hydroxymethyl)anthraquinone) and chrysophanol (1,8-dihydroxy-3-methyl-9,10-anthraquinone);

wintergreen such as chimaphilin (2,7-dimethyl-1,4-naphthoquinone);

Nigella sativa L. seeds and oil such as thymoquinone, dithymoquinone, and thymolhydroquinone;

henna plant leaves such as 2-hydroxy-2,4-napthoquinone;

red clover and alfalfa such as caffeoquinone (caffeic acid quinone), chlorogenic acid quinone.

olive tree leaves such as olive leaf oil (oleuropein);

cinchona tree bark such as quinine;

echinacea roots such as caffeic acid, chlorogenic acid;

cannabis such as cannabidiol (CBD), myrcene; and/or

certain amino acids such as cystine, cysteine, homocysteine, methionine, taurine, N-formyl methionine.

Embodiments of the present invention relate to an organic peroxide formulation comprising, consisting essentially of, or consisting of at least one organic peroxide, and at least one natural or naturally derivable scorch retardant additive.

Embodiments of the present invention relate to a method for manufacturing the organic peroxide formulation, the method comprising, consisting of, or consisting essentially of mixing the at least one organic peroxide, and the at least one natural or naturally derivable scorch retardant additive.

Embodiments of the present invention also relate to a polymer composition comprising, consisting essentially of, or consisting of at least one polymer, at least one organic peroxide, and at least one natural or naturally derivable scorch retardant additive.

Embodiments of the present invention also relate to a process for curing an elastomer composition, said process comprising, consisting essentially of, or consisting of curing a polymer composition, wherein the polymer composition comprises, consists essentially of, or consists of at least one polymer, at least one organic peroxide, and at least one natural or naturally derivable scorch retardant additive. Embodiments of the present invention also relate to products made by this process.

### DESCRIPTION OF THE DRAWINGS

FIG. 1 (Example 4) depicts the improvement in scorch time obtained using certain embodiments of the invention.

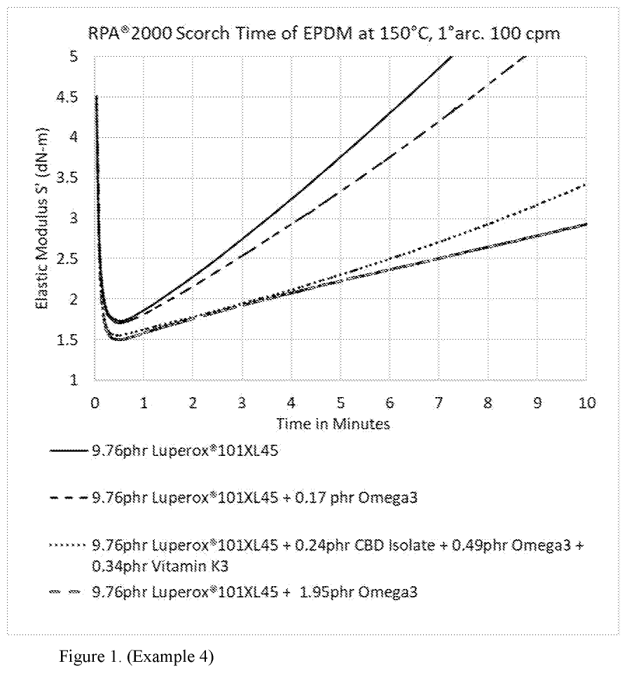

FIG. 2 (Example 4) depicts the improvement in scorch time at 180° C. and the cure performance obtained using certain embodiments of the invention at full cure.

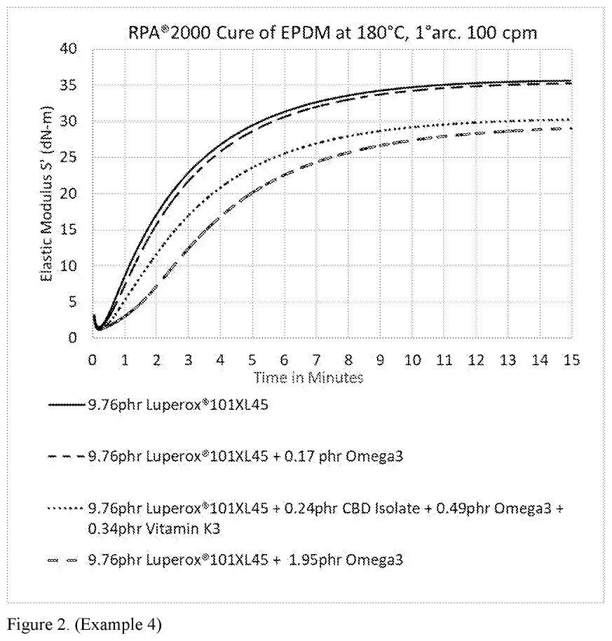

FIG. 3 (Example 5) depicts the improvement in scorch time obtained using certain embodiments of the invention.

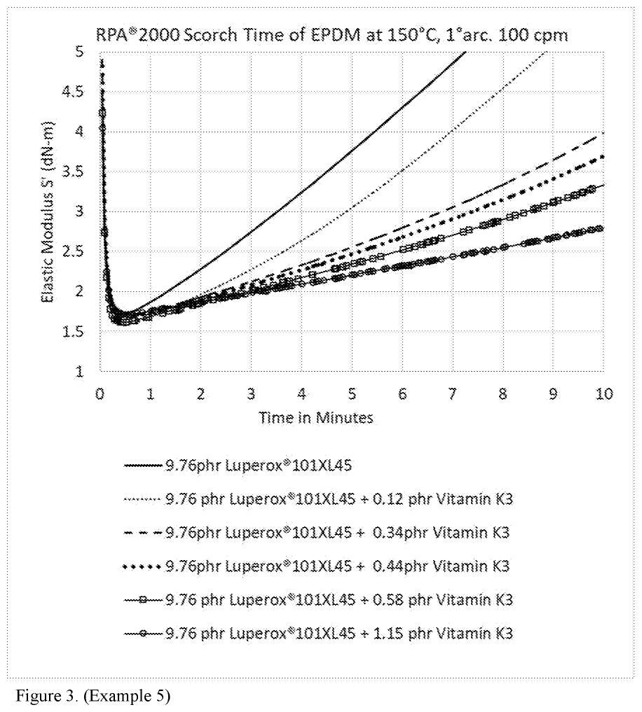

FIG. 4 (Example 5) depicts the improvement in scorch time at 180° C. and the cure performance obtained using certain embodiments of the invention at full cure.

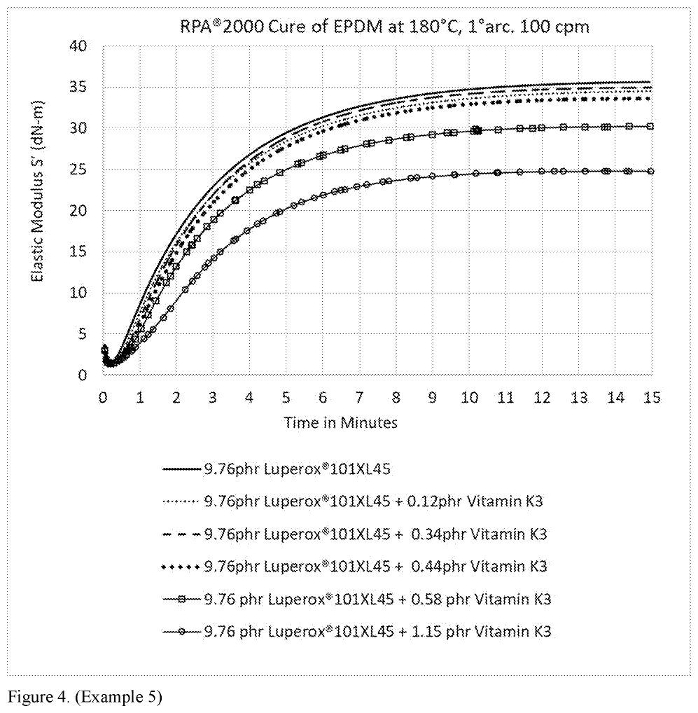

FIG. 5 (Example 6) depicts the improvement in scorch time obtained using certain embodiments of the invention.

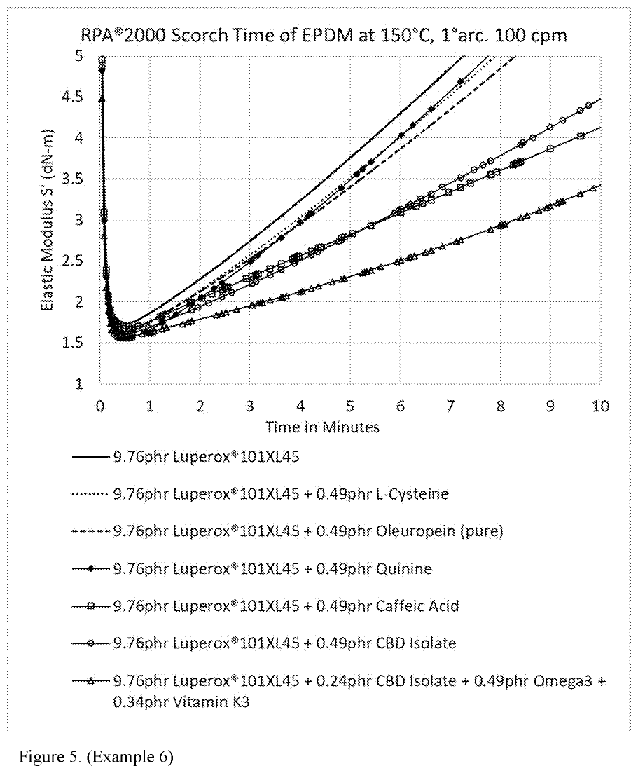

FIG. 6 (Example 6) depicts the improvement in scorch time at 180° C. and the cure performance obtained using certain embodiments of the invention at full cure.

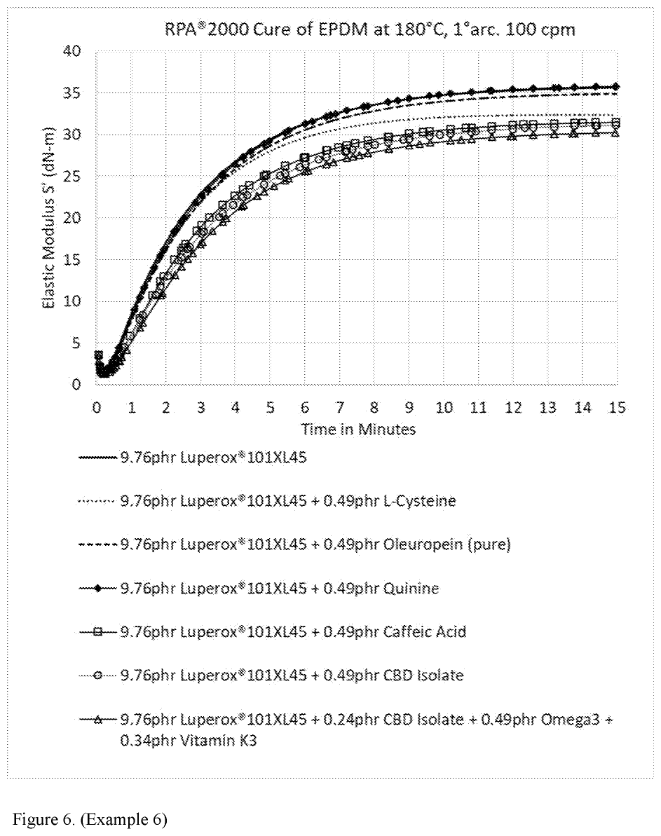

FIG. 7 (Example 7) depicts the improvement in scorch time obtained using certain embodiments of the invention.

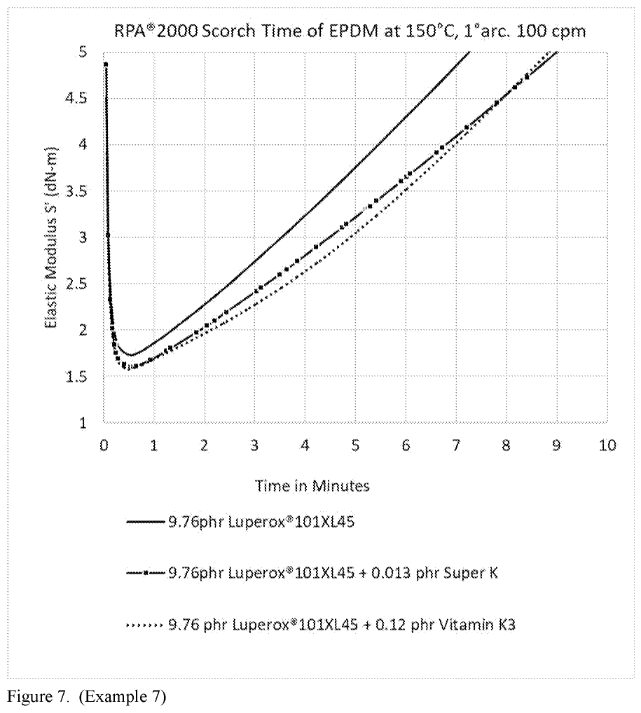

FIG. 8 (Example 7) depicts the improvement in scorch time at 180° C. and the cure performance obtained using certain embodiments of the invention at full cure.

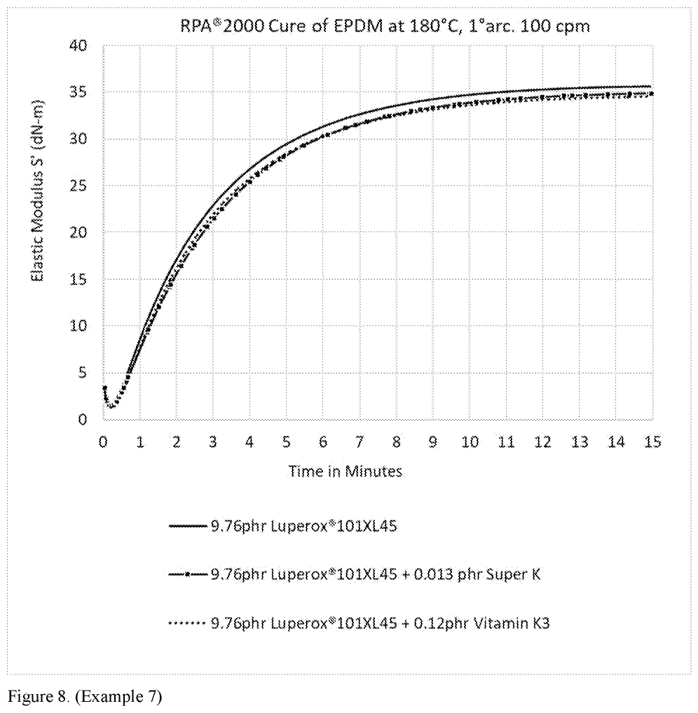

### DETAILED DESCRIPTION

Unless otherwise indicated, all percentages herein are weight percentages.

“Polymer” as used herein, is meant to include organic molecules with a weight average molecular weight higher than 10,000 g/mole, preferably 20,000 g/mol, more preferably higher than 50,000 g/mol, as measured by gel permeation chromatography. The term “polymer” encompasses homopolymers and copolymers, where the term “copolymers” refers to a polymer comprised of at least two different monomers in polymerized form. For example, a copolymer in accordance with the present disclosure may be a polymer comprising two different monomers, a terpolymer is a polymer comprising three different monomers or more. The terms, “rubber” and “elastomer” are considered to be synonymous with “polymer”, and refer to those materials that can be crosslinked with organic peroxides.

The term, “natural”, as used herein means a compound that may be found in nature. The term “natural” also covers compounds that are found in nature, but subsequently purified and/or chemically altered, e.g. derivatized or processed in some way.

The terms, “naturally derived from” or “naturally derivable” mean that such compounds may be a chemically produced equivalent of such compounds that may be found in nature to provide the equivalent scorch retardant additive.

The term, “extractable” in reference to certain compounds does not mean that the compound was, in fact extracted from the source recited (usually a plant), but rather that the although compound exists naturally in such a plant, it can be/was produced synthetically.

As used herein, the term “curing” refers to the crosslinking of a polymer to form a strengthened or hardened polymer. A curing step may be performed in any conventional manner.

“Scorch” is defined herein as the unwanted crosslinking or modification of a polymer, rubber, elastomer or resin that occurs during a processing step.

The applicants have discovered that various natural or naturally derivable compounds are effective scorch retardant additives for organic peroxides.

An organic peroxide formulation comprising, consisting of, or consisting essentially of, at least one organic peroxide and at least one natural or naturally derivable scorch retardant additive is provided. The formulation preferably includes no intentionally added water as a component, although water may be present in the composition in amounts that are due to ambient humidity, water of hydration of certain additives, or additional water due to hygroscopic additives, for example. Preferably, water is present in the formulation at levels of not more than 5 wt %, 4 wt %, 3 wt %, 2 wt %, 1 wt %, 0.5 wt %, or not more than 1000 ppm weight, by weight of the total formulation of peroxide and scorch retardant additive.

In certain embodiments, the at least one natural or naturally derivable scorch retardant additive is extractable from at least one of the group consisting of thyme, kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, or cannabis. In certain embodiments, the at least one natural or naturally derivable scorch retardant additive may comprises at least one amino acid.

In some embodiments, the at least one natural or naturally derivable scorch retardant additive may be selected from the group consisting of thymol, Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, cannabidiol, myrcene, cystine, cysteine, homocysteine, methionine, taurine, N-formyl methionine, and mixtures thereof.

In some embodiments, the at least one natural or naturally derivable scorch retardant additive may be preferably selected from the group consisting of Vitamin K and derivatives thereof, such as Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, and mixtures thereof.

According to certain embodiments, the weight percent of these scorch protective additives in the organic peroxide (neat peroxide being the basis for calculations) formulation may be: 35 wt % or less of the scorch protective additive added to the neat peroxide; preferably 20 wt % or less, more preferably 15 wt % or less, more preferably 10 wt % or less, preferably 8 wt % or less depending upon the need for scorch protection.

The peroxides and peroxide formulations comprising the peroxide and the naturally derived or derivable scorch retarders may be extended on fillers, to provide a free-flowing powder product or masterbatch, as is known in the art. Non-limiting examples of such fillers comprise calcium carbonate, Burgess Clay, precipitated silica, microcellulose, cellulose acetate butyrate (CAB), calcium silicate, silica, fly ash, dried wood flour, dried saw dust, dried straw particles/flour, polyethylene in powder or pellet form, or mixtures thereof. Preferred are Burgess Clay, precipitated calcium carbonate, precipitated silica, calcium silicate, microcellulose, cellulose acetate butyrate, high density polyethylene powder, polypropylene powder and mixtures thereof. Most preferred are Burgess clay, precipitated silica, calcium silicate, high density polyethylene powder, and mixtures thereof.

All those organic peroxides known to undergo decomposition by heat to generate radicals capable of initiating the desired curing (crosslinking) reactions are contemplated as suitable for use in the formulations of the present invention. Non-limiting examples include dialkyl peroxides, diperoxyketals, peroxyketals; hemi-perketal peroxides; mono-peroxy carbonates, cyclic ketone peroxides, diacyl peroxides, organosulfonyl peroxides, peroxyesters and solid, room temperature stable peroxydicarbonates, and mixtures thereof. The peroxides may be liquid or solid.

Peroxide names and physical properties for all these classes of organic peroxides can be found in “Organic Peroxides” by Jose Sanchez and Terry N. Myers; Kirk-Othmer Encyclopedia of Chemical Technology, Fourth Ed., Volume 18, (1996), the disclosure of which is incorporated herein by reference.

Illustrative dialkyl peroxides include:

di-t-butyl peroxide; t-amyl t-butyl peroxide; t-butyl cumyl peroxide; t-amyl cumyl peroxide; dicumyl peroxide; 2,5-di(cumylperoxy)-2,5-dimethyl hexane; 2,5-di(cumylperoxy)-2,5-dimethyl hexyne-3; 4-methyl-4-(t-butylperoxy)-2-pentanol; 4-methyl-4-(t-amylperoxy)-2-pentanol; 4-methyl-4-(cumylperoxy)-2-pentanol; 4-methyl-4-(t-butylperoxy)-2-pentanone; 4-methyl-4-(t-amylperoxy)-2-pentanone; 4-methyl-4-(cumylperoxy)-2-pentanone; 2,5-dimethyl-2,5-di(t-butylperoxy)hexane; 2,5-dimethyl-2,5-di(t-amylperoxy)hexane; 2,5-dimethyl-2,5-di(t-butylperoxy)hexyne-3; 2,5-dimethyl-2,5-di(t-amylperoxy)hexyne-3; 2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; m/p-di(t-butylperoxy)diisopropyl benzene; p-di(t-butylperoxy)diisopropyl benzene; m-di(t-butylperoxy) diisopropyl benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumylperoxide; t-amyl-isopropenylcumylperoxide; 2,4,6-tri(butylperoxy)-s-triazine; 1,3,5-tri[1-(t-butylperoxy)-1-methylethyl]benzene; 1,3,5-tri-[(t-butylperoxy)-isopropyl]benzene; 1,3-dimethyl-3-(t-butylperoxy)butanol; 1,3-dimethyl-3-(t-amylperoxy)butanol; and mixtures thereof.

Another class of dialkylperoxides which may be used singly or in combination with the other free radical crosslinkers contemplated by the present disclosure are those selected from the group represented by the formula:

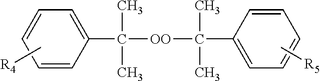

wherein R₄ and R₅ may independently be in the meta or para positions and are the same or different and are selected from hydrogen or straight or branched chain alkyls of 1 to 6 carbon atoms. Dicumyl peroxide and isopropylcumyl cumyl peroxide are illustrative.

Other dialkyl peroxides include: 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl}1-methylethyl]carbamate; 1,3-dimethyl-3-(t-amylperoxy)butyl N-[1-{3-(1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate.

In the group of diperoxyketal peroxides, the preferred peroxides include: 1,1-di(t-butylperoxy)-3,3,5-trimethylcyclohexane; 1,1-di(t-amylperoxy)-3,3,5-trimethylcyclohexane; 1,1-di(t-butylperoxy)cyclohexane; 1,1-di(t-amylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate; and mixtures thereof.

Other peroxides that may be used according to at least one embodiment of the present disclosure include OO-t-butyl-O-hydrogen-monoperoxy-succinate and OO-t-amyl-O-hydrogen-monoperoxy-succinate.

Illustrative cyclic ketone peroxides are compounds having the general formulae (I), (II) and/or (III).

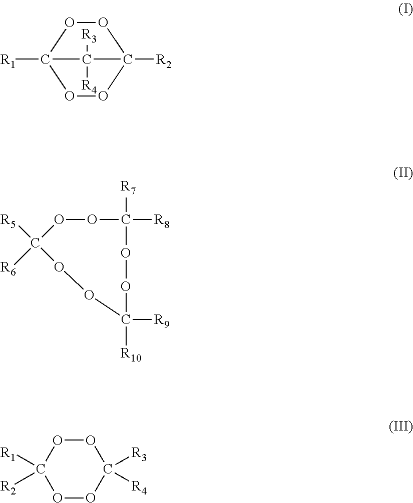

wherein R₁ to R₁₀ are independently selected from the group consisting of hydrogen, C1 to C20 alkyl, C3 to C20 cycloalkyl, C6 to C20 aryl, C7 to C20 aralkyl and C7 to C20 alkaryl, which groups may include linear or branched alkyl properties and each of R₁ to R₁₀ may be substituted with one or more groups selected from hydroxy, C1 to C20 alkoxy, linear or branched C1 to C20 alkyl, C6 to C20 aryloxy, halogen, ester, carboxy, nitride and amido, such as, for example, at least 20% of the total active oxygen content of the peroxide mixture used for a crosslinking reaction will be from compounds having formulas (I), (II) and/or (III).

Some examples of suitable cyclic ketone peroxides include: 3,6,9, triethyl-3,6,9-trimethyl-1,4,7-triperoxynonane (or methyl ethyl ketone peroxide cyclic trimer) or Trigonox® 301 from Nouryon and 3,3,5,7,7-Pentamethyl-1,2,4-trioxepane or Trigonox® 311 from Nouryon; methyl ethyl ketone peroxide cyclic dimer, and 3,3,6,6,9,9-hexamethyl-1,2,4,5-tetraoxacyclononane.

Illustrative examples of peroxyester peroxides include: 2,5-dimethyl-2,5-di(benzoylperoxy)hexane; t-butylperbenzoate; t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate.

Illustrative monoperoxy carbonates include: OO-t-butyl-O-isopropylmonoperoxy carbonate; OO-t-butyl-O-(2-ethyl hexyl)monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,1-tris[2-(cumylperoxy-cabonyloxy)ethoxymethyl]propane; OO-t-amyl-O-isopropylmonoperoxy carbonate.

Illustrative diacyl peroxides include: di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide; succinic acid peroxide; di(2,4-dichloro-benzoyl)peroxide.

Non-limiting illustrative examples of Peroxyesters include: 2,5-dimethyl-2,5-di(benzoylperoxy)hexane; t-butylperbenzoate; t-butylperoxyacetate; t-butylperoxy-2-ethyl hexanoate; t-amylperbenzoate; t-amyl peroxy acetate; t-butyl peroxy isobutyrate; 3-hydroxy-1,1-dimethyl t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate.

Illustrative monoperoxy carbonates include: OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,1-tris[2-(cumylperoxy-carbonyloxy)ethoxymethyl]propane; OO-t-amyl-O-isopropylmonoperoxy carbonate. Other peroxides that may be used according to at least one embodiment of the present disclosure include the functionalized peroxyester type peroxides: OO-t-butyl-O-hydrogen-monoperoxy-succinate; OO-t-amyl-O-hydrogen-monoperoxysuccinate; OO-t-amylperoxymaleic acid; OO-t-butylperoxymaleic acid; t-butylperoxy-isopropenylcumylperoxide and t-amylperoxy-isopropenylcumylperoxide.

Also suitable in the practice of this invention is an organic peroxide branched oligomer comprising at least three peroxide groups comprises a compound represented by structure below:

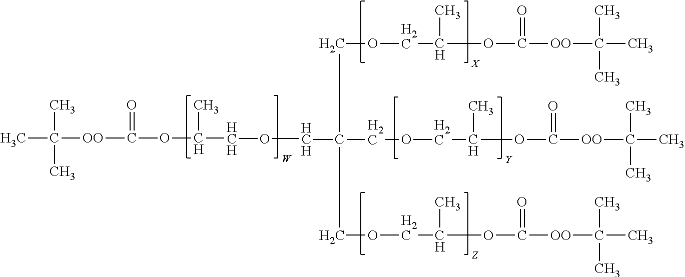

In the above structure, the sum of W, X, Y and Z is 6 or 7. One example of this type of uniquely branched organic peroxide is the tetrafunctional polyether tetrakis(t-butylperoxy monoperoxycarbonate).

Illustrative hemi-peroxyketal class of organic peroxides include: 1-methoxy-1-t-amylperoxycyclohexane (Luperox® V10); 1-methoxy-1-t-butylperoxycyclohexane; 1-methoxy-1-t-amylperoxy-3,3,5 trimethylcyclohexane; 1-methoxy-1-t-butylperoxy-3,3,5 trimethylcyclohexane. Imido peroxides of the type described in WO9703961 are also suitable for use and incorporated by reference herein.

In some embodiments, a blend of an organic peroxide and the scorch retardant additive is contemplated wherein the organic peroxide is at least one organic peroxide selected from the group consisting of 1,1-di(t-butyperoxy)-3,3,5-trimethyl cyclohexane, dicumyl peroxide, m/p-di(t-butylperoxy)diisopropyl benzene, and 2,5-dimethyl-2,5-di(t-butylperoxy)hexane and the at least one natural or naturally derivable scorch retardant additive is at least one selected from the group consisting of Vitamin K1 (phytonadione or phylloquinone), Vitamin K2 (menaquinone), Vitamin K3 (menadione),Vitamin K2 MK-4 (menatetrenone), Vitamin K2 MK-7 (menaquinone-7), Vitamin K2 MK-14 (menaquinone 14), Vitamin K2 menatetrenone epoxide, and mixtures thereof.

Another embodiment comprises, consists of, or consists essentially of a blend of an organic peroxide comprising 2,5-dimethyl-2,5-di(t-butylperoxy)hexane and a natural or naturally derivable scorch retardant Vitamin K3 (menadione) to form a liquid peroxide formulation.

Another embodiment may comprise, consist of, or consist essentially of a blend of an organic peroxide comprising 2,5-dimethyl-2,5-di(t-butylperoxy)hexane and a natural or naturally derivable scorch retardant comprising cannabidiol and/or thymol and or myrcene.

These peroxide formulations may be extended on inert filler(s) to form a free-flowing powder. Non-limiting examples of such fillers may be selected from Hi-Sil® 233 silica, Burgess clay, precipitated calcium carbonate, calcium silicate or a blend of the these fillers. This free-flowing powder scorch protected peroxide formulation may be compounded into commercially available polymer masterbatches comprising either EPDM, VMQ (silicone rubber), bromobutyl rubber or HNBR as the carrier, using an internal Brabender mixer.

Crosslinked goods may be formed by compression molding of these compositions.

Another embodiment may be a blend of at least one organic peroxide selected from the group consist of di-t-butyl peroxide, di-t-amyl peroxide 2,5-dimethyl-2,5-di(t-butylperoxy)hexane, t-amyl t-butyl peroxide, and combinations thereof, and wherein the natural or naturally derivable scorch retardant additive may be selected from thymol, myrcene, cannabidiol, Vitamin K3 (menadione), Vitamin K2 (menequinone), aloe-emodin, cystine, cysteine, quinine, caffeic acid, olive leaf oil (oleuropein), and mixtures thereof, to form a liquid peroxide formulation.

According to another embodiment this liquid peroxide formulation may be further mixed with a liquid coagent selected from the group consisting of trimethylolpropane trimethacrylate or propoxylated 3-trimethylolpropane triacrylate, trimethylolpropane triacrylate and combinations thereof.

These liquid scorch protected peroxide formulations can be used separately or combined in an extrusion process to produce crosslinked HDPE (crosslinked high density polyethylene) tubing or pipe for potable water applications known as PEX-a. Another crosslinking application for these liquid peroxide formulations may be crosslinked HDPE rotational molded tanks or tank inner liners for potable water containment.

Another embodiment may comprise, consist of, or consist essentially of a blend of organic peroxides selected from di-t-butyl peroxide, di-t-amyl peroxide and a combination thereof, wherein the natural or naturally derivable scorch retardant additive may be selected from cannabidiol, myrcene, quinine, oleuropein, thymoquinone, thymol, and a combination thereof, to form a liquid peroxide formulation. According to another embodiment, this liquid peroxide formulation may be further mixed with a liquid coagent selected from trimethylolpropane trimethacrylate, propoxylated 3-trimethylolpropane triacrylate, trimethylolpropane triacrylate, and a combination thereof to form a liquid peroxide formulation.

Another embodiment may comprise, consist of, or consist essentially of a blend of organic peroxide dicumyl peroxide, Burgess clay filler, and/or silica filler, and a natural or naturally derivable scorch retardant additive selected from the group consisting of quinine, oleuropein (olive leaf oil), Vitamins (K1, K2 or K3), caffeic acid, myrcene, cannabidiol and a combination thereof to form a free flowing powder peroxide formulation for the curing of two separate commercially compounded EPDM and HNBR masterbatches.

Another embodiment may comprise, consist of, or consist essentially of a blend of 1,1-di(t-butyperoxy)-3,3,5-trimethyl cyclohexane and the natural or naturally derivable scorch retarding additive selected from 2-hydroxy-2,4-napthoquinone (henna plant leaves) and/or cannabidiol and/or myrcene (cannabis) and/or thymol (from the herb thyme) to form a liquid peroxide formulation.

Another embodiment may comprise, consist of, or consist essentially of a blend of t-butylperbenzoate and the scorch retarding additive selected from the group consisting of thymoquinone, myrcene, cannabidiol, and combination of these additives to form a liquid peroxide formulation.

Another embodiment may comprise, consist of, or consist essentially of a blend of 1,1-di(t-butyperoxy)-3,3,5-trimethyl cyclohexane and the natural or naturally derivable scorch retarding additive selected from the group consisting of thymol, thymoquinone, myrcene, cannabidiol, and a combination of additives and the coagent trimethylolpropane triacrylate to create a liquid peroxide formulation.

Another embodiment may comprise, consist of, or consist essentially of a blend of 1,1-di(t-butyperoxy)-3,3,5-trimethyl cyclohexane and the natural or naturally derivable scorch retarding additive selected from the group consisting of thymoquinone, myrcene, cannabidiol and a combination of additives and the coagent trimethylolpropane triacrylate and Hi-Sil® 233 silica wherein the final peroxide formulation may be in the form of a free-flowing powder.

Another embodiment may comprise, consist of, or consist essentially of a blend of 1,1-di(t-butyperoxy)-3,3,5-trimethyl cyclohexane and the scorch retarding additive selected from the group consisting of Vitamin K3, thymol, thymoquinone, oleuropein, myrcene and cannabidiol or a combination of these additives and Hi-Sil® 233 silica filler to produce a free-flowing peroxide formulation. This peroxide formulation may be utilized in a dynamic vulcanization process to create a TPV (thermoplastic vulcanizate) wherein small particles of crosslinked EPDM are created in a continuous polypropylene matrix. Thus, this scorch retarded peroxide formulation in the form of a free-flowing powder may be compounded into a mixture of EPDM and polypropylene using a Brabender mixer along with white process oil and carbon black filler. For example, the temperature is initially set to about 50° C. and the mixing of all components begins, wherein the elastomer temperature begins to rise due to shear heating. The electrical heater of the mixer head is then adjusted to the 1 minute half-life of the peroxide formulation (152.8° C.). The EPDM/polypropylene elastomer mixture slowly increases in temperature. Once the set temperature is reached the mixing continues for 8 minutes to decompose all of the peroxide to create an improved thermoplastic vulcanizate (TPV) compared to one made using a standard peroxide formulation without natural or naturally derivable scorch retarding additives.

Furthermore, it is unexpectedly discovered that the scorch protected peroxyketal and hemi-peroxyketal classes of peroxides provided superior performance versus the other classes of peroxides for producing an EPDM and PP type TPV.

In accordance with particular embodiments, organic peroxide formulations of the present invention may further include at least one crosslinking coagent and/or at least one filler. According to particular embodiments, examples of crosslinking co-agents include allyl methacrylate, triallyl cyanurate, triallyl isocyanurate, trimethyloylpropane trimethacrylate (SR-350®), trimethyloylpropane triacrylate (SR-351®), zinc diacrylate, and zinc dimethacrylate.

Additional non-limiting examples of crosslinking coagents include

Sartomer-manufactured methacrylate-type coagents, such as: SR205H triethylene glycol dimethacrylate (TiEGDMA), SR206H ethylene glycol dimethacrylate (EGDMA), SR209 tetraethylene glycol dimethacrylate (TTEGDMA), SR210HH polyethylene glycol (200) dimethacrylate (PEG200DMA), SR214 1,4-butanediol dimethacrylate (BDDMA), SR231 diethylene glycol dimethacrylate (DEGDMA), SR239A 1,6-hexanediol dimethacrylate (HDDMA), SR252 polyethylene glycol (600) dimethacrylate (PEG600DMA), SR262 1,12-dodecanediol dimethacrylate (DDDDMA), SR297J 1,3-butylene glycol dimethacrylate (BGDMA), SR348C ethoxylated 3 bisphenol A dimethacrylate (BPA3EODMA), SR348L ethoxylated 2 bisphenol A dimethacrylate (BPA2EODMA), SR350D trimethylolpropane trimethacrylate (TMPTMA), SR480 ethoxylated 10 bisphenol A dimethacrylate (BPA10EODMA), SR540 ethoxylated 4 bisphenol A dimethacrylate (BPA4EODMA), SR596 alkoxylated pentaerythritol tetramethacrylate (PETTMA), SR604 polypropylene glycol monomethacrylate (PPGMA), SR834 tricyclodecanedimethanol dimethacrylate (TCDDMDMA), and SR9054 acidic difunctional adhesion promoter;

Sartomer-manufactured acrylate-type coagents, such as: SR238 1,6-hexanediol diacrylate (HDDA), SR259 polyethylene glycol (200) diacrylate (PEG200DA), SR268G Ttetraethylene glycol diacrylate (TTEGDA), SR272 Triethylene glycol diacrylate (TIEGDA), SR295 pentaerythritol tetraacrylate (PETTA), SR306 tripropylene glycol diacrylate (TPGDA), SR307 polybutadiene diacrylate (PBDDA), SR341 3-methyl 1,5-pentanediol diacrylate (MPDA), SR344 polyethylene glycol (400) diacrylate (PEG400DA), SR345 High performance high functional monomer, SR349 ethoxylated 3 bisphenol A diacrylate (BPA3EODA), SR351 Ttrimethylolpropane triacrylate (TMPTA), SR355 di-trimethylolpropane tetraacrylate (Di TMPTTA), SR368 tris (2-hydroxyethyl) isocyanurate triacrylate (THEICTA), SR399 dipentaerythritol pentaacrylate (Di PEPA), SR415 ethoxylated (20) trimethylolpropane triacrylate (TMP20EOTA), SR444 modified pentaerythritol triacrylate, SR444D pentaerythritol triacrylate (PETIA), SR454 ethoxylated 3 trimethylolpropane triacrylate (TMP3EOTA), SR492 propoxylated 3 trimethylolpropane triacrylate (TMP3POTA), SR494 ethoxylated 4 pentaerythritol tetraacrylate (PETTA), SR499 ethoxylated 6 trimethylolpropane triacrylate (TMP6EOTA), SR502 ethoxylated 9 trimethylolpropane triacrylate (TMP9EOTA), SR508 dipropylene glycol diacrylate (DPGDA), Saret® SR522D dry liquid concentrate of cyclic-alkane diacrylate, SR534D multifunctional acrylate ester, SR595 1,10 decanediol diacrylate (DDDA), SR601 ethoxylated 4 bisphenol A diacrylate (BPA4EODA), SR602 ethoxylated 10 bisphenol A diacrylate (BPA10EODA), SR606A esterdiol diacrylate (EDDA), SR610 polyethylene glycol 600 diacrylate (PEG600DA), SR802 alkoxylated diacrylate, SR833S tricyclodecanedimethanol diacrylate (TCDDMDA), SR9003 propoxylated 2 neopentyl glycol diacrylate (PONPGDA), SR9020 propoxylated 3 glyceryl triacrylate (GPTA), SR9035 ethoxylated 15 trimethylolpropane triacrylate (TMP15EOTA), and SR9046 ethoxylated 12 glyceryl triacrylate (G12EOTA);

Sartomer-manufactured special scorch protected type coagents, such as:

Saret® 297F liquid scorch protected methacrylate, Saret® 350S liquid scorch protected methacrylate, Saret® 350W liquid scorch protected methacrylate, Saret® 500 liquid scorch protected methacrylate, Saret® 517R trimethylolpropane triacrylate liquid scorch protected methacrylate, Saret® 521 diethylene glycol dimethacrylate (a liquid scorch protected methacrylate) and Saret® PRO13769; allylic-type coagents such as, SR507A triallyl cyanurate (TAC), SR533 triallyl isocyanurate (TAIC), triallylphosphate (TAP), triallyl borate (TAB), trimethallyl isocyanurate (TMAIC), diallylterephthalate (DATP) aka diallyl phthalate, diallyl carbonate, diallyl maleate, diallyl fumarate, diallyl phosphite, trimethylolpropane diallyl ether; poly(diallyl isophthalate), and glyoxal bis(diallyl acetal) (1,1,2,2-tetraallyloxyethane); hybrid-type coagents such as allyl methacrylate, allyl acrylate, allyl methacrylate oligomer, allyl acrylate oligomer, and Sartomer SR523, new dual functional coagent (an allyl methacrylate or acrylate derivative); 2,4-diphenyl-4-methyl-1-pentene, also known as Nofmer® MSD (alpha-methylstyrene dimer) (available from Nippon Oil & Fat Co., particularly for wire and cable applications);

and miscellaneous other crosslinking coagents, such as:

N,N′-m-phenylenedimaleimide, also known as HVA-2 (available from DuPont), N,N′-p-phenylenedimaleimide, cis-1,2-polybutadiene (1,2-BR), divinylbenzene (DVB), and 4,4′-(bismaleimide) diphenyl disulphide.

Non-limiting examples of optional inert fillers for use in the organic peroxide formulations of the present invention include water washed clay, e.g., Burgess Clay, precipitated silica, precipitated calcium carbonate, synthetic calcium silicate, and combinations thereof. Various combinations of these fillers can be used by one skilled in the art to achieve a free-flowing, non-caking final peroxide formulation.

In accordance with particular embodiments, the organic peroxide formulations of the present invention may include a silica filler.

The organic peroxide formulations of the present invention may optionally include at least one additive selected from the group consisting of process oils (e.g., aliphatic process oils), process aids, pigments, dyes, tackifiers, waxes, reinforcing aids, UV stabilization agents, blowing agents, activators, antioxidants and coagents (e.g., those marketed by Sartomer).

According to one embodiment, a method for manufacturing the organic peroxide formulation comprises, consists of, or consists essentially of mixing the at least one organic peroxide, and the at least one natural or naturally derivable scorch retardant additive. The mixing may be done using any method as are known and used in the art. For example, the mixing may be performed in equipment such as a Ross® mixer, a low-shear ribbon mixer, or a Brabender° mixer.

According to another embodiment, a polymer composition comprising, consisting of or consisting essentially of at least one polymer, at least one organic peroxide, and at least one natural or naturally derivable scorch retardant additive is provided.

In at least one embodiment, the polymer compositions of the present invention may comprise a saturated polymer, an unsaturated polymer, or a blend of both a saturated and unsaturated polymer.

It should be noted that commercially-available pre-compounded polymers may be used in accordance with the present invention. These polymers may contain additives such as carbon black filler, process oils, mold release agents, antioxidants and/or heat stabilizers. According to particular embodiments, the at least one polymer is part of a polymer masterbatch that includes one or more of these additives. For example, a polymer masterbatch may comprise, consist essentially of, or consist of the at least one polymer and one or more additives selected from the group consisting of carbon black, polyethylene glycol, at least one process oil (e.g., liquid saturated hydrocarbons, such as Primol® 352), at least one antioxidant (e.g., 2,2,4-trimethyl-1,2-dihydroquinoline, also referred to as TMQ), at least one mold release agent, at least one heat stabilizer, and a combination thereof.

In at least one embodiment, the polymer of the polymer composition comprises a copolymer. The embodiments disclosed herein recite elastomer compositions comprising a copolymer. However, as one of ordinary skill in the art would readily appreciate, a homopolymer may be substituted in any embodiment comprising a copolymer, unless expressly indicated to the contrary.

According to at least one embodiment, the polymer composition may comprise, consist of, or consist essentially of at least one saturated polymer. The saturated polymer can be selected from, for example, silicon rubber without unsaturation (Q), methyl-polysiloxane (MQ), phenyl-methyl-polysiloxane (PMQ), poly[ethylene vinyl acetate] (EVA), high-density polyethylene (HDPE), low-density polyethylene (LDPE), linear low density polyethylene (LLDPE), Dow Engage® type poly(ethylene octene and/or hexene) copolymers, chlorinated poly(ethylene) (CPE), chlorosulfonated polyethylene (CSM), polyamide type polymer (PA-11), polylactic acid (PLA), DuPont Vamac® poly(ethylene methylacrylate); poly(ethylene propylene) (EPM), fluoroelastomers (FKM, FFKM) (e.g., Viton® and Dyneon®), and combinations thereof.

According to at least one embodiment, the polymer composition may comprise, consist of, or consist essentially of at least one unsaturated polymer. Unsaturated polymers that may be used in the polymer composition include, for example, poly[ethylene-propylene-diene] terpolymer (EPDM), vinyl silicone rubber (VMQ), fluorosilicone (FVMQ), nitrile rubber (NBR), acrylonitrile-butadiene-styrene (ABS), styrene butadiene rubber (SBR), styrene-butadiene-styrene block copolymers (SBS), polybutadiene rubber (BR), styrene-isoprene-styrene block copolymers (SIS), partially hydrogenated acrylonitrile butadiene (HNBR), natural rubber (NR), synthetic polyisoprene rubber (IR), neoprene rubber (CR), polychloropropene, bromobutyl rubber (BIIR), chlorobutyl rubber (CIIR), and combinations thereof.

In accordance with at least one embodiment, the polymer composition comprises at least one saturated copolymer. Non-limiting examples of saturated polymers that may be used include copolymers of ethylene with propylene, butylene, pentene, hexane, heptane, octane, and vinyl acetate, such as, ultrahigh molecular weight polyethylene (UHMWPE) linear low density polyethylene (LLDPE), low density polyethylene (LDPE), high density polyethylene (HDPE), medium density polyethylene (MDPE), poly(ethylene vinyl acetate) (EVA), poly(ethylene propylene) (EPM), poly(ethylene octene) (e.g., Engage®), poly(ethylene hexene), poly(ethylene butylene) (e.g., Tafmer®), Vamac® polymers (e.g., poly(ethylene methyl acrylate), poly(ethylene acrylate), and combinations with acrylic acid), and combinations thereof.

In accordance with certain embodiments, the following polymers may be used: metallocene based polyethylenes such as mLLDPE, mHDPE; chlorinated polyethylene (CM or CPE), chlorosulfonated)polyethylene (CSM), poly(ethylene vinylacetate) (EVA), ethylene propylene diene (EPDM elastomers [dienes for EPDM include ethylidene norbornene (ENB), dicyclopentadiene (DCPD), and vinyl norbornene (VNB)]; ethylene propylene rubber (EPM). Various types of polyamides may be used in certain embodiments include homopolymers, copolymers, terpolymers. Non-limiting examples are those in the art as: PA11, PA12 PA6, PA66, PA610, PA612, PA1010, PA1012, PA6/66, PA66/610, PAmXD6, PA6I, Rilsan® polyamides, Hiprolon® polyamides, Pebax® polyether block polyamides, Platamid® copolyamides, Cristamid® copolyamides, further including but not limited to Hiprolon®70, Hiprolon®90, Hiprolon®200, Hiprolon®400, Hiprolon®11, Hiprolon®211 (all available from Arkema, Inc.).

Bio-based polymers and copolymers may be used in some embodiments.

Non-limiting examples of suitable bio-based polymers are aliphatic biopolyesters such as polylactic acid (PLA), also referred to as polylactide, polyhydroxyalkanoates (PHAs), polyhydroxybutyrate (PHB), poly(3-hydroxy valerate) (PHV), polyhydroxyhexanoate (PHH), polyglycolic acid (PGA), and poly-ε-caprolactone (PCL). Polyamide 11, a biopolymer derived from natural oil (castor bean oil) may be suitable for use in certain embodiments. It is known under the tradename Rilsan® B (Arkema). Polyamide 410 (PA 410), derived 70% from castor oil, under the trade name EcoPaXX® (DSM) may be used in certain embodiments. The preferred bio-based polymers are the polylactic acid type polymers.

Bio-based polyamides may include but are not limited to aliphatic, semi-aromatic, aromatic, and/or aliphatic grafted polyamide polymers and/or copolymers and/or blends of these resins including but not limited to the following: bio-based versions of the polyamides commonly known as PA4, PA6, PA66, PA46, PA9, PA11, PA12, PA610, PA612, PA1010, PA1012, PA6/66, PA66/610, PAmXD6, PA6I; Rilsan® polyamides, Hiprolon® polyamides, Pebax® polyether block polyamides, Platamid® copolyamides, Cristamid® copolyamides, further including but not limited to Hiprolon®70, Hiprolon®90, Hiprolon®200, Hiprolon®400, Hiprolon®11, Hiprolon®211 (all available from Arkema, Inc.). Suitable bio-based polyamides also include TERRYL brand polyamides available from Cathay Industrial Biotech, Shanghai, China (PA46, PA6, PA66, PA610, PA 512, PA612, PA514, PA1010, PA11, PA1012, PA 12, PA1212), ExcoPAXX® polyamides available from DSM, Singapore, Vestamide® polyamides available from Evonik, Germany, semi-aromatic polyamides (e.g., PA6T, poly(hexamethyleneterephthalamide), such as Trogamid® polyamides available from Evonik and Amodel® polyamides available from Solvay, Alpharetta, Ga.) or Vicnyl® polyamides including PA10T, PA9T from Kingfa Sci. & Tech Co, China, and Nylon®, Zytel® RS and “PLS” product lines (e.g., RSLC, LC including glass reinforced and impact modified grades), Elvamide® multi-polymer polyamides, Minion®, Zytel® LCPA, Zytel® PLUS polyamides from DuPont, Wilmington, Del., and aromatic type polyamides (e.g., poly(paraphenyleneterephthalamide), such as, Kevlar® and Nomex® polyamides from DuPont, Teijinconex®, Twaron® and Technora® polyamides from Teijin, Netherlands and Japan, and Kermel® polyamides from Kermel, Swicofil AG, Switzerland). Also suitable are the “bio-polyamide” polyamides derived using YXY building block monomers such as 2,5-furandicarboxylic acid and/or 2,5-hydroxymethyl tetrahydrofuran monomers derived from sugars (e.g., 5-hydroxymethyl furfural) from Solvay/Avantium including bio-based polyamides from Rhodia/Avantium, the Technyl® copolyamides from Solvay/Rhodia e.g., Technyl® 66/6, the hot melt adhesives Vestamelt® polyamides from Evonik, H1001w polyamide from Shanghai Farsseing Hotmelt Adhesive Co., Lanxess Durathan® polyamides e.g., Durathan® C131F PA6/6I copolyamide, Priplast® modified coplyamide elastomers by Croda Coatings & Polymers, Rowalit® polyamides by Rowak AG, Nylonxx® and Nylonxp® polyamides from Shanghai Xinhao Chemical Co., Ultramid® polyamide grades from BASF, Griltex® copolyamides by EMS-Griltech, and Euremelt® copolyamides from Huntsman. Blends of these materials may be used.

The term “poly(lactic acid)” (PLA) as used herein refers to a polymer or copolymer containing at least 10 mol % of lactic acid monomer units. Examples of poly(lactic acid) include, but are not limited to, (a) a homopolymer of lactic acid, (b) a copolymer of lactic acid with one or more aliphatic hydroxycarboxylic acids other than lactic acid, (c) a copolymer of lactic acid with an aliphatic polyhydric alcohol and an aliphatic polycarboxylic acid, (d) a copolymer of lactic acid with an aliphatic polycarboxylic acid, (e) a copolymer of lactic acid with an aliphatic polyhydric alcohol, and (f) a mixture of two or more of (a)-(e) above. Examples of the lactic acid include L-lactic acid, D-lactic acid, DL-lactic acid, a cyclic dimer thereof (i.e., L-lactide, D-lactide or DL-lactide) and mixtures thereof. Examples of the hydroxycarboxylic acid, useful for example in copolymers (b) and (f) above include, but are not limited to, glycolic acid, hydroxybutyric acid, hydroxyvaleric acid, hydroxycaproic acid and hydroxyheptoic acid, and combinations thereof. Examples of the aliphatic polyhydric alcohol monomers useful for example in the copolymers (c), (e), or (f) above include, but are not limited to, ethylene glycol, 1,4-butanediol, 1,6-hexanediol, 1,4-cyclohexanedimethanol, neopentyl glycol, decamethylene glycol, glycerin, trimethylolpropane and pentaerythritol and combinations thereof. Examples of the aliphatic polycarboxylic acid monomers useful for example in the copolymers (c), (d), or (f) above include, but are not limited to, succinic acid, adipic acid, suberic acid, sebacic acid, dodecanedicarboxylic acid, succinic anhydride, adipic anhydride, trimesic acid, propanetricarboxylic acid, pyromellitic acid and pyromellitic anhydride and combinations thereof.

In some embodiments, cellophane; cellulose esters, cellulose acetate; HNBR (hydrogenated nitrile rubber); XNBR (carboxylated nitrile rubber); NBR (nitrile rubber), SBR (styrene butadiene rubber), SBS (styrene butadiene styrene block copolymer), SSBR (anionic polymerized in solution SBR); bromobutyl rubber (BIIR); chlorobutyl rubber (CIIR), polychloroprene (CR or Neoprene® DuPont), natural rubber, cis-polyisoprene, isoprene rubber (IR), polybutadiene rubber (BR), high vinyl polybutadiene rubber (HVBR), acrylated terminated/functionalized polybutadiene, MQ silicone rubber, VMQ vinyl silicone rubber, fluoroelastomers (FKM), Kynar® from Arkema, Viton® from the Chemours Company, Aflas® type polymers, e.g., AFLAS® 600X fluoroelastomer from AGC Chemicals, DAT-EL® fluoroelastomer and perfluoroelastomers from Daikin America e.g., DAI-EL® G-801 from Daikin; perfluoroelstomers (FFKM), fluoro-silicone rubber (FVMQ), DuPont Vamac®, poly(ethylene methacrylate or acrylate) type copolymers and terpolymers; ACM (polyacrylic rubber); poly(ethylene acrylic acid) (EAA); Ethylene vinyltrimethoxysilane copolymer; and mixtures thereof.

Another embodiment of the present invention relates to a method for manufacturing an article comprising a polymer composition as described herein, wherein the method comprises curing the polymer composition.

The method may comprise extruding a polymer composition, as described herein, to form an uncured preform article, and curing the uncured preform article.

The process may further comprise mixing the components separately or together, and in any order, to provide the polymeric composition.

In at least one embodiment, one or more conventional additives such as antioxidants (e.g., hindered phenols and polymeric quinoline derivatives), aliphatic process oils, process aids, pigments, dyes, tackifiers, waxes, reinforcing aids, UV stabilization agents, blowing agents, scorch protectors, activators, antioxidants or coagents may also be added to any of the elastomer compositions described herein before, after and/or during the curing step.

Non-limiting examples of applications for the scorch retarded peroxide formulations of the present invention include the use the organic peroxide formulation for crosslinked high density polyethylene rotational molding; injection molded, compression molded, transfer molded and then crosslinked goods; extruded and crosslinked wire and cable insulation; extruded and crosslinked hose; rubber roller compounds; rubber conveyor belts for industrial and food applications; extruded and crosslinked continuous sealing profile for use in automotive, architectural, industrial and/or window sealing applications; general crosslinked elastomers, rubber and polymers; dynamic vulcanization for production of TPV (thermoplastic vulcanizates); and crosslinked rubber or polymer foams. Other non-limiting examples of uses for these scorch-protected peroxide formulations include: producing various goods that could comply with NSF or FDA indirect food contact or medical applications. Non-limiting examples of these various goods would be PEX-A pipe and tubes (abbreviation for peroxide crosslinked potable water pipes and tubes), crosslinked rubber septum seals for liquid drug ampules, crosslinked rubber seal plungers used in disposable syringes, crosslinked rubber gaskets used in coffee makers, rotomolded crosslinked or partially crosslinked polyethylene tanks used for potable water storage or as a crosslinked polyethylene inner liner for hot water tanks. Other non-limiting examples of uses for these formulations of scorch protected peroxide include: automotive and industrial crosslinked polymeric seals; crosslinked heat shrinkable seals, crosslinked O-rings, various types of crosslinked hose, crosslinked belts and crosslinked gaskets; crosslinked wire and cable insulation; crosslinked insulation for high voltage power distribution cables, crosslinked golf ball cores; crosslinked oil and gas seals, crosslinked tubing, crosslinked hose, crosslinked drill stators, crosslinked blow out preventer seals; industrial window profiles; crosslinked ethylene vinyl acetate copolymer (EVA) encapsulant used in photovoltaic modules; foamed and non-foamed crosslinked shoe soles, and various crosslinked (also referred to as cured) elastomer components of athletic and conventional shoes; crosslinked cable covering; and production of various thermoplastic vulcanizates (TPV's).

Non-limiting examples of applications for the peroxide formulations of the present invention include the use of liquid and filler-extended grades of the organic peroxides for crosslinked HDPE rotational molding; PEX-a pipe production; injection molded, compression molded, transfer molded crosslinked goods; wire and cable; general crosslinked elastomers, rubber and polymers; modification of polymer molecular weight and grafting of agents such as maleic anhydride (MAH) and glycidyl methacrylate; dynamic vulcanization for production of TPV (thermoplastic vulcanizates); and crosslinked rubber or polymer foams.

According to another embodiment, when producing a thermoplastic vulcanizates (TPV) by dynamic vulcanization, PP (polypropylene homopolymer) and/or polypropylene copolymers (comprising low levels <5 wt % to <2 wt % of co-monomers such as ethylene) may be used in the practice of this invention. As is known in the art, thermoplastic vulcanizate (TPV) is a dynamically vulcanized alloy consisting mostly of fully cured ethylene propylene diene (EPDM) rubber particles encapsulated in a polypropylene (PP) matrix. Without being bound by theory, in certain embodiments, the scorch protected peroxide formulation disclosed herein may allow for a better dispersion of a crosslinkable elastomer prior to the crosslinking reaction, e.g., crosslinking of EPDM dispersed particles in the PP polymer continuous matrix (wherein the PP matrix does not crosslink), to create the TPV by a dynamic vulcanization process. The use of the scorch protected peroxide of this invention will allow for the desired dispersion of uncured EPDM rubber particles in the PP matrix. Afterwards, the scorch protected peroxide will be allowed to fully decompose in order to crosslink the EPDM elastomer phase. The end result is a continuous phase of PP containing better dispersed crosslinked EPDM rubber particles of more uniform size due to more mixing time as a result of a longer processing time or longer scorch time, prior to crosslinking of the EPDM phase. The final TPV feels like a rubber but is thermoplastic and can flow when heat is applied and can be injection molded.

According to another embodiment, the scorch retardant additives disclosed herein may be blended with controlled temperature stable and/or room temperature stable peroxides (e.g., certain Peroxyesters) for the curing of polyester resins or other resins, e.g., Elium® acrylate solutions (available from Arkema) combined with fiberglass for a pultrusion, or vacuum impregnation process, or cure in place pipe application and the like.

Excluded from the practice of this invention as described herein are dibenzoyl peroxide, hydrogen peroxide, hydroperoxides, and inorganic peroxides, and liquid peroxydicarbonates.

Non-limiting aspects of this disclosure may be summarized below:

Aspect 1: An organic peroxide formulation comprising:
at least one organic peroxide, and
at least one natural or naturally derivable scorch retardant additive.

Aspect 2: The organic peroxide formulation of Aspect 1, wherein the at least one natural or naturally derivable scorch retardant additive is extractable from at least one of the group consisting of thyme, kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, cannabis, and amino acids.

Aspect 3: The organic peroxide formulation of either Aspect 1 or Aspect 2, wherein the at least one natural or naturally derivable scorch retardant additive is selected from the group consisting of thymol, Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, myrcene, cannabidiol, cystine, cysteine, homocysteine, methionine, taurine, N-formyl methionine, and mixtures thereof.

Aspect 4: The organic peroxide formulation of any of Aspects 1-3, wherein the at least one natural or naturally derivable scorch retardant additive is selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (Menaquinone 14), Vitamin K2 menatetrenone epoxide, and mixtures thereof.

Aspect 5: The organic peroxide formulation of any of Aspects 1-4, wherein the at least one natural or naturally derivable scorch retardant additive is selected from the group consisting of thymol, oleuropein, myrcene and cannabidiol, and mixtures thereof.

Aspect 6: The organic peroxide formulation of any of Aspects 1-5 further comprising at least one crosslinking coagent comprising a moiety having at least two functional groups,

wherein said functional groups are selected from the groups consisting of allylic,

methacrylic, acrylic, maleimide, vinyl, and may be the same or different.

Aspect 7: The organic peroxide formulation of any of Aspects 1-6, wherein the at least one peroxide comprises at least one selected from the group consisting of diacyl peroxides (excluding dibenzoyl peroxide); dialkyl peroxides; diperoxyketal peroxides, hemi-perketal peroxides; monoperoxycarbonates; cyclic ketone peroxides; peroxyesters; and peroxydicarbonates.

Aspect 8: A method for manufacturing the organic peroxide formulation of any of Aspects 1-7 comprising mixing the at least one organic peroxide, the at least one natural or naturally derivable scorch retardant additive, and optionally at least one crosslinking coagent.

Aspect 9: A polymer composition comprising:
at least one polymer,
at least one organic peroxide, and
at least one natural or naturally derivable scorch retardant additive.

Aspect 10:The polymer composition of Aspect 9, wherein the at least one natural or naturally derivable scorch retardant additive is extractable from at least one of the group consisting of thyme, cannabis, kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, and amino acids.

Aspect 11: The polymer composition of either Aspect 9 or Aspect 10, wherein the at least one natural or naturally derivable scorch retardant additive is selected from the group consisting of thymol, myrcene, cannabidiol, Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, cystine, cysteine, homocysteine, methionine, taurine, N-formyl methionine, and mixtures thereof.

Aspect 12: The polymer composition of any of Aspects 9-11, wherein the at least one natural or naturally derivable scorch retardant additive is selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, and mixtures thereof.

Aspect 13: The polymer composition of any of Aspects 9-12, wherein the at least one natural or naturally derivable scorch retardant additive is selected from the group consisting of thymol, oleuropein, myrcene, cannabidiol, and mixtures thereof.

Aspect 14: The polymer composition of any of Aspects 8-13, further comprising at least one crosslinking coagent comprising a moiety having at least two functional groups,

wherein said functional groups are selected from the groups consisting of allylic, methacrylic, acrylic, maleimide, vinyl, and may be the same or different.

Aspect 15: The polymer composition of any of Aspects 9-14, wherein the at least one

peroxide comprises one or more of a dialkyl, peroxyketal, hemi-perketal, peroxyester, or monoperoxycarbonate type peroxide.

Aspect 16: The polymer composition of any of Aspects 9-15, wherein the at least one polymer is selected from the group consisting of polyethylene homopolymers, copolymers and terpolymers; chlorinated polyethylene; chlorosulfonated polyethylene, poly(ethylene vinylacetate); ethylene vinyltrimethoxysilane copolymer; ethylene propylene diene elastomers (EPDM); ethylene propylene elastomers (EPM); polyamide homopolymers, copolymers, terpolymers; bio-polyesters and copolymers; polylactic acid (PLA), poly(L-lactide-co-D,L-lactide), polyglycolic acid (PGA), poly-ε-caprolactone (PCL), polyhydroxybutyrate (PHB), and poly(3-hydroxy valerate); cellophane; cellulose esters, cellulose acetate; hydrogenated nitrile rubber (HNBR); carboxylated nitrile butadiene rubber (XNBR); acrylonitrile butadiene rubber (NBR); styrene butadiene rubber (SBR); styrene butadiene styrene block copolymer (SBS); anionic polymerized in solution styrene butadiene styrene block copolymer (SSBR); bromobutyl rubber (BIM); chlorobutyl rubber (CIIR); polychloroprene; natural rubber; cis-polyisoprene; polybutadiene rubber (BR); high vinyl polybutadiene rubber (HVBR); acrylated terminated and/or functionalized polybutadiene; methyl silicone rubber (MQ); vinyl methyl silicone rubber (VMQ); phenyl methyl silicone rubber (PMQ); fluorosilicone rubber (FVMQ); FKM fluoroelastomers; perfluoroelastomers (FFKM); poly(ethylene (meth)acrylate) copolymers; poly(ethylene (meth)acrylate) terpolymers; polyacrylic rubber (ACM); and poly(ethylene acrylic acid) EAA; and mixtures thereof.

Aspect 17: A process for curing a polymer composition, said process comprising:

curing a polymer composition,

wherein the polymer composition comprises at least one polymer, at

least one organic peroxide, and at least one natural or naturally derivable scorch retardant additive.

Aspect 18: A polymeric article manufactured according to the process of Aspect 17.

The following examples further illustrate the best mode contemplated by the inventors for the practice of their invention and are to be construed as illustrative and not in limitation thereof.

### EXAMPLES

The test methods below use the Alpha Technologies RPA®2000 Rheometer:

ASTM D5289-19a (2019) Standard Test Method for Rubber Property—Vulcanization Using Rotorless Cure Meters.

This method is used to measure the increase in shear modulus in dN-m versus time in minutes at a constant temperature when the various peroxide formulations are tested. This is used to also measure the amount of scorch time in minutes.

ASTM D6601-19 (2019) Standard Test Method for Rubber Properties—Measurement of Cure and After-Cure Dynamic Properties Using a Rotorless Shear Rheometer.

This method is used to measure the increase in shear modulus in dN-m versus time in minutes at a constant temperature and then after the polymer modification was completed, to study the effect of the final polymer's viscosity versus shear rate. This test is used when partial crosslinking is done to modify a polymer.

Examples 1-3 are prophetic examples.

### Example 1

### Preparation of a Liquid Scorch Protected Solution “101-K3” (Prophetic)

Using a Ross mixer, the following are added and mixed for 30 minutes at ambient temperature to create a liquid scorch protected peroxide formulation: 93.0 wt % Luperox® 101(Arkema) [94% assay 2,5-dimethyl-2,5-di(t-butylperoxy)hexane] (87.42 wt % pure basis); and 7.0 wt % Vitamin K3 [Menadione] to form a 100 wt % total scorch protected liquid peroxide formulation “101-K3” with a 87.42 wt % peroxide assay.

### Example 2

### Preparation of a Free Flowing Solid Scorch Protected Peroxide Formulation (Prophetic)

Using a low shear ribbon blender (Marion® mixer), two inert fillers (calcium carbonate and silica) are added to the blender and thoroughly mixed. Then the liquid peroxide formulation “101-K3” is sprayed slowly over a period of 30 minutes onto the fillers while the ribbon blender continues to operate and mix for an additional 45 minutes after the liquid addition to ensure uniform blending of the peroxide solution.

162 kg precipitated calcium carbonate
300 kg Hi-Sil ^{®} ABS silica from PPG
538 kg “101-K3” peroxide solution from Example 1
This results in 1000 kg of a free flowing powder labeled “101-K3-XL47”. (53.8 wt % 101-K3 was added to filler powder) × 87.42 wt % Luperox ^{®} 101 peroxide = 47 wt % pure peroxide assay in “101-K3-XL47”.

### Example 3

### (Prophetic)

When compounding rubber using an internal mixer, a solid powder form of peroxide is generally preferred for ease of accuracy and process safety to add solid free flowing powders to a rubber formulation. In this example, two free flowing peroxide powder formulations are mixed into an EPDM rubber masterbatch, using an internal Brabender® mixer from C. W. Brabender with a 50 cc bowl.

Mixing takes place at 25 rpm for a total of 6 minutes for each peroxide test to form an EPDM Masterbatch with a compound density of 1.10 g/ml.

| Ingredient | grams |
|---|---|
| Vistaion ^{®} 2504 EPDM from ExxonMobil | 100.00 |
| N550 carbon black | 100.00 |
| Primol ^{®} 352 oil (ExxonMobil) | 40.00 |
| PEG (polyethylene glycol) | 3.00 |
| TMQ (antioxidant) | 1.00 |
| Total EPDM Masterbatch | 244.00 |

Mixing control using Luperox® 101XL45 (containing 47 wt % 2,5-dimethyl-2,5-di(t-butylperoxy)hexane peroxide). Mixing is conducted for 6 minutes at 50° C.

| | |
|---|---|
| Standard peroxide | “Scorch protected” |
| “Control” mixing test | mixing test |
| 50 grams EPDM Masterbatch | 50 grams EPDM Masterbatch |
| 6 grams Luperox ^{®} 101XL45 | 6 grams “101-K3-XL47” |
| (47 wt % assay) | (47 wt % assay) |

Samples of each compounded EPDM rubber are run on an Alpha Technologies RPA 2000 at 162° C. using a 1 degree arc and 100 cpm frequency. The EPDM “Scorch protected” rubber sample provides a much longer ts2 (min) scorch time compared to the “Control” samples. The results of this test proves the more desirable longer processing safety with the “101-K3-XL47” peroxide sample, vs the standard peroxide Luperox® 101XL45. The compounded rubber containing the scorch protected peroxide has better flow properties based on a lower ML (dN-m) value and a lower viscosity value vs when using the standard peroxide.

### Example 4

In this example peroxide in powder form, specifically Luperox® 101XL45 was added to an EPDM rubber masterbatch, using an internal Brabender® mixer from C. W. Brabender with a 50 cc bowl. In some cases immediately after adding the peroxide, various scorch retarders of our invention derived from natural sources were also added and mixed into the rubber masterbatch.

### EPDM Masterbatch Composition

| Ingredient | grams |
|---|---|
| Vistaion ^{®} 2504 EPDM from ExxonMobil | 100.00 |
| N550 carbon black | 100.00 |
| Primol ^{®} 352 oil (ExxonMobil) | 40.00 |
| PEG (polyethylene glycol) | 3.00 |
| TMQ (antioxidant) | 1.00 |
| Total EPDM Masterbatch | 244.00 |

Total mixing time was six minutes at 25 rpm at 50 C-60 C for each experiment, to form EPDM Masterbatch samples for analysis on our RPA® 2000 rheometer from Alpha Technologies.

Luperox® 101XL45 contains 47 wt % 2,5-dimethyl-2, 5-di(t-butylperoxy)hexane peroxide on inert fillers. 50 grams of the EPDM masterbatch was added to the mixer in each case. Also in each case 2.0 grams of Luperox® 101XL45 was added which is equivalent to 9.76 phr (parts per 100 parts of pure EPDM rubber). The control is the use of the peroxide with no additive. Different novel scorch retarding additives of our invention were also added with the peroxide to the rubber at various phr amounts and tested using a rheometer at 150° C. and 180° C. Please see the data in the two tables below as well as the two corresponding rheographs.

RPA ^{®} 2000 Rheometer Scorch data at 150° C., 1 deg. arc, 100 cpm frequency

| | | 9.76 phr | 9.76 phr | |
|---|---|---|---|---|
| | | Luperox ^{®} | Luperox ^{®}101XL45 + | 9.76 phr |
| | 9.76 phr | 101XL45 + | 0.24 phr CBD Isolate + | Luperox ^{®} |
| | Luperox ^{®} | 0.17 phr | 0.49 phr Omega3 + | 101XL45 + |
| | 101XL45 | Omega3 | 0.34 phr Vitamin K3 | 1.95 phr Omega3 |
| Min S′ (ML) dN-m | 1.73 | 1.70 | 1.56 | 1.50 |
| Time @ 0.4 dNm scorch S′ (min) | 1.87 | 2.13 | 3.64 | 3.51 |
| Time @ 0.5 dNm scorch S′ (min) | 1.89 | 2.13 | 3.65 | 3.51 |
| Time @ 1 dNm (min) | 2.98 | 3.43 | 6.27 | 6.97 |
| Time @ 1.5 dNm (min) | 3.99 | 4.69 | 8.54 | 10.54 |
| Time @ 2 dNm (min) | 4.95 | 5.88 | 10.50 | 13.91 |

RPA ^{®} 2000 Rheometer Cure data at 180° C., 1 deg. arc, 100 cpm frequency

| | | | 9.76 phr | 9.76 phr |
|---|---|---|---|---|
| | | 9.76 phr | Luperox ^{®} 101XL45 + | Luperox ^{®} |
| | 9.76 phr | Luperox ^{®} | 0.24 phr CBD Isolate + | 101XL45 + |
| | Luperox ^{®} | 101XL45 + | 0.49 phr Omega3 + | 1.95 phr |
| | 101XL45 | 0.17 phr Omega3 | 0.34 phr Vitamin K3 | Omega3 |
| Min S′ (ML) dN-m | 1.52 | 1.46 | 1.33 | 1.26 |
| Max S′ (MH) dN-m | 35.64 | 35.28 | 30.28 | 28.99 |
| Max S′-Min S′ dN-m | 34.12 | 33.81 | 28.96 | 27.73 |
| Time @ 0.4 dNm scorch S′ (min) | 0.32 | 0.35 | 0.44 | 0.49 |
| Time @ 0.5 dNm scorch S′ (min) | 0.34 | 0.36 | 0.44 | 0.50 |
| Time @ 1 dNm (min) | 0.41 | 0.45 | 0.55 | 0.71 |
| Time @ 1.5 dNm (min) | 0.46 | 0.52 | 0.64 | 0.90 |
| Time @ 2 dNm (min) | 0.52 | 0.58 | 0.72 | 1.06 |
| Time @ 50% cure (min) | 2.21 | 2.39 | 2.75 | 3.58 |
| Time @ 90% cure (min) | 6.63 | 6.90 | 7.38 | 8.57 |

This example shows that by varying the amount of Omega 3, various amounts of scorch time protection can be obtained at 150° C. This example also illustrates that a blend of various naturally sourced additives (CBD Isolate and Vitamin K3) can be used to achieve a balance of cure and scorch time. The concentrations of both the peroxide and the additives may be optimized to obtain the scorch and cure time performance desired to meet performance targets. Even at 180° C. (where complete cure was obtained), it can be seen that an increase in scorch protection for better mold filling at this high cure temperature is possible. CBD isolate is a form of CBD, or cannabidiol, which is a chemical compound present in the cannabis plant.

### Example 5

In this example using the same EPDM rubber and procedure for mixing in Example 4, Vitamin K3 was added at various phr loadings combined with the constant use of 9.76 phr Luperox® 101XL45 as can be seen in the two tables and two rheographs below. The compounded rubber samples were then tested using the RPA® rheometer at 150° C. and 180° C. as before. Please see the scorch and cure data in the two tables below as well as the two corresponding rheographs. By adjusting (increasing) the phr loading of Vitamin K3, it is possible to increase the scorch time performance of the rubber at 150° C. while providing desirable cure performance at 180° C. Even at 180° C. it can be seen that an increase in scorch protection for better mold filling at this high cure temperature is possible. At 0.34 phr use level of Vitamin K3 we obtained a 76% increase in the ts0.4 dN-m scorch time in minutes versus the use of peroxide alone (3.30 minutes when using the vitamin versus 1.87 minutes). This ts0.4 dN-m scorch S′ time is the time to attain a 0.4 dN-m rise above the minimum torque (ML). Furthermore, as the minimum torque is lower when using the vitamin additive versus the peroxide used alone, the effective scorch time benefit is actually longer than reported on this table for the 0.34 phr Vitamin K3 result as the additive is producing a better (lower) ML or minimum torque. When using the vitamin, the time to rise to a 0.4 dN-m higher modulus will still result in a lower modulus value (less viscosity) versus the peroxide control, as the peroxide control is starting from a higher ML modulus value. This ML or minimum (modulus) torque relates to the viscosity of the compound and so during the mixing of rubber with peroxide, the rubber may increase in viscosity when the rubber increases in temperature, which can cause a very small amount of the peroxide to decompose. In summary, the scorch additives of this invention offer an additional benefit as they help to maintain a lower viscosity after the mixing of rubber is completed. We saw a similar effect of the different additives on the ML even in the previous Example #4.

RPA ® 2000 Rheometer Scorch data at 150° C., 1 deg. arc, 100 cpm frequency

| | | 9.76 phr | 9.76 phr | 9.76 phr | 9.76 phr | 9.76 phr |
|---|---|---|---|---|---|---|
| | | Luperox ® | Luperox ® | Luperox ® | Luperox ® | Luperox ® |
| | 9.76 phr | 101XL45 + | 101XL45 + | 101XL45 + | 101XL45 + | 101XL45 + |
| | Luperox ® | 0.12 phr | 0.34 phr | 0.44 phr | 0.58 phr | 1.15 phr |
| | 101XL45 | Vitamin K3 | Vitamin K3 | Vitamin K3 | Vitamin K3 | Vitamin K3 |
| Min S′ (ML) dN-m | 1.73 | 1.58 | 1.69 | 1.69 | 1.61 | 1.71 |
| Time@0.4 dNm scorch S′ (min) | 1.87 | 2.38 | 3.30 | 3.54 | 3.64 | 5.05 |
| Time@0.5 dNm scorch S′ (min) | 1.89 | 2.38 | 3.32 | 3.55 | 3.64 | 5.06 |
| Time@1 dNm (min) | 2.98 | 3.84 | 5.56 | 6.01 | 6.49 | 9.27 |
| Time@1.5 dNm (min) | 3.99 | 5.06 | 7.48 | 8.14 | 8.99 | 13.01 |
| Time@2 dNm (min) | 4.95 | 6.13 | 9.12 | 9.96 | 11.17 | >>15.00 (n/a) |

RPA ® 2000 Rheometer Cure data at 180° C., 1 deg. arc, 100 cpm frequency

| | | 9.76 phr | 9.76 phr | 9.76 phr | 9.76 phr | 9.76 phr |
|---|---|---|---|---|---|---|
| | | Luperox ® | Luperox ® | Luperox ® | Luperox ® | Luperox ® |
| | 9.76 phr | 101XL45 + | 101XL45 + | 101XL45 + | 101XL45 + | 101XL45 + |
| | Luperox ® | 0.12 phr | 0.34 phr | 0.44 phr | 0.58 phr | 1.15 phr |
| | 101XL45 | Vitamin K3 | Vitamin K3 | Vitamin K3 | Vitamin K3 | Vitamin K3 |
| Min S′ (ML) dN-m | 1.52 | 1.34 | 1.45 | 1.41 | 1.40 | 1.43 |
| Max S′ (MH) dN-m | 35.64 | 34.53 | 34.92 | 33.62 | 30.22 | 24.81 |
| Max S′ − Min S′ dN-m | 34.12 | 33.19 | 33.47 | 32.20 | 28.82 | 23.38 |
| Time@0.4 dNm scorch S′ (min) | 0.32 | 0.39 | 0.42 | 0.42 | 0.42 | 0.49 |
| Time@0.5 dNm scorch S′ (min) | 0.34 | 0.39 | 0.42 | 0.42 | 0.43 | 0.49 |
| Time@1 dNm (min) | 0.41 | 0.46 | 0.51 | 0.53 | 0.55 | 0.64 |
| Time@1.5 dNm (min) | 0.46 | 0.52 | 0.59 | 0.62 | 0.65 | 0.77 |
| Time@2 dNm (min) | 0.52 | 0.57 | 0.66 | 0.69 | 0.74 | 0.89 |
| Time@50% cure (min) | 2.21 | 2.26 | 2.35 | 2.38 | 2.42 | 2.78 |
| Time@90% cure (min) | 6.63 | 6.68 | 6.53 | 6.51 | 6.49 | 6.49 |

### Example 6

In this example various additives were used at an arbitrary use level of 0.49 phr to simply illustrate that Cysteine, oleuropein, quinine, caffeic acid and CBD isolate can be used alone or in combinations to provide an increase in scorch time. In the case of oleuropein we only had access to powdered olive leaf extract which contains 20% active oleuropein. Therefore, the amount of olive leaf extract was adjusted in the rubber to provide 0.49 phr of actual oleuropein (pure), the essential active ingredient of olive leaves. In each case when the additives were used, an increase in the scorch times were obtained at 150° C. based on the data from the table below and the corresponding RPA® 2000 rheograph. The last column, which used a mixture of additives had used the various compounds at different phr loadings as an illustration of mixing these various additives can be useful.

RPA ® 2000 Rheometer Scorch data at 150° C., 1 deg. arc, 100 cpm frequency

| | | | | | | | 9.76 phr |
|---|---|---|---|---|---|---|---|
| | | | | | | | Luperox ® |
| | | | | | | | 101XL45 + |
| | | | 9.76 phr | | 9.76 phr | 9.76 phr | 0.24 phr |
| | | 9.76 phr | Luperox ® | 9.76 phr | Luperox ® | Luperox ® | CBD Isolate + |
| | | Luperox ® | 101XL45 + | Luperox ® | 101XL45 + | 101XL45 + | 0.49 phr |
| | 9.76 phr | 101XL45 + | 0.49 phr | 101XL45 + | 0.49 phr | 0.49 phr | Omega3 + |
| | Luperox ® | 0.49 phr | Oleuropein | 0.49 phr | Caffeic | CBD | 0.34 phr |
| | 101XL45 | L-Cysteine | (pure) | Quinine | Acid | Isolate | Vitamin K3 |
| Min S′ (ML) dN-m | 1.73 | 1.671 | 1.632 | 1.558 | 1.669 | 1.612 | 1.56 |
| Time@0.4 dNm scorch S′(min) | 1.87 | 2.06 | 2.00 | 2.03 | 2.49 | 2.63 | 3.64 |
| Time@0.5 dNm scorch S′(min) | 1.89 | 2.07 | 2.01 | 2.03 | 2.49 | 2.63 | 3.65 |
| Time@1 dNm (min) | 2.98 | 3.22 | 3.25 | 3.15 | 4.42 | 4.35 | 6.27 |
| Time@1.5 dNm(min) | 3.99 | 4.30 | 4.41 | 4.17 | 6.33 | 5.96 | 8.54 |
| Time@2 dNm (min) | 4.95 | 5.31 | 5.49 | 5.14 | 8.25 | 7.48 | 10.50 |

RPA Rheometer Cure data at 180° C., 1 deg. arc, 100 cpm frequency)

| | | | | | | | 9.76 phr |
|---|---|---|---|---|---|---|---|
| | | | | | | | Luperox ® |
| | | | | | | | 101XL45 + |
| | | | 9.76 phr | | | 9.76 phr | 0.24 phr |
| | | 9.76 phr | Luperox ® | 9.76 phr | 9.76 phr | Luperox ® | CBD Isolate + |
| | | Luperox ® | 101XL45 + | Luperox ® | Luperox ® | 101XL45 + | 0.49 phr |
| | 9.76 phr | 101XL45 + | 0.49 phr | 101XL45 + | 101XL45 + | 0.49 phr | Omega3 + |
| | Luperox ® | 0.49 phr | Oleuropein | 0.49 phr | 0.49 phr | CBD | 0.34 phr |
| | 101XL45 | L-Cysteine | (pure) | Quinine | Caffeic Acid | Isolate | Vitamin K3 |
| Min S′ (ML) dN-m | 1.52 | 1.459 | 1.409 | 1.359 | 1.452 | 1.391 | 1.33 |
| Max S′ (MH) dN-m | 35.64 | 32.394 | 34.922 | 35.808 | 31.531 | 31.179 | 30.28 |
| Max S′ − Min S′ dN-m | 34.12 | 30.936 | 33.513 | 34.449 | 30.080 | 29.788 | 28.96 |
| Time@0.4 dNm scorch S′ (min) | 0.32 | 0.35 | 0.35 | 0.35 | 0.35 | 0.39 | 0.44 |
| Time@0.5 dNm scorch S′ (min) | 0.34 | 0.35 | 0.35 | 0.35 | 0.37 | 0.39 | 0.44 |
| Time@1 dNm (min) | 0.41 | 0.42 | 0.42 | 0.42 | 0.46 | 0.48 | 0.55 |
| Time@1.5 dNm (min) | 0.46 | 0.48 | 0.49 | 0.48 | 0.55 | 0.56 | 0.64 |
| Time@2 dNm (min) | 0.52 | 0.53 | 0.55 | 0.53 | 0.63 | 0.64 | 0.72 |
| Time@50% cure (min) | 2.21 | 2.08 | 2.29 | 2.28 | 2.50 | 2.63 | 2.75 |
| Time@90% cure (min) | 6.63 | 5.73 | 6.70 | 6.73 | 6.96 | 7.38 | 7.38 |

### Example 7

In this example we used an over-the-counter vitamin product called “Super K with Advanced K2 complex” by Life Extension. One gel capsule was broken and the liquid suspension containing vitamin with inert oils was added (˜0.25 g) to 50 grams of the EPDM compound described in Example 4, along with 9.76 phr of Luperox® 101XL45.

According to the vitamin bottle supplemental facts, one capsule has 2600 mcg of Vitamin K activity. 2600 mcg is equivalent to 2.6 mg or 0.0026 g of Vitamin K activity comprised of:

| | |
|---|---|
| Vitamin K1 as phytonadione .............. | 1500 mcg |
| Vitamin K2 as menaquinone-4 ............ | 1000 mcg |
| Vitamin K2 as trans menaquinone-7 ..... | 100 mcg |

The use of 0.0026 g of Vitamin K activity (referred to in the table as Super K) to 50 g of EPDM compound which contains 20.49 g of EPDM results in a use level of 0.01268 phr or rounding to about 0.013 phr of Super K (K1 and K2). Compare the performance of 0.013 phr Super K at 150° C. to the use of 0.12 phr of Vitamin K3 in the table below.

It is quite surprising how effective such a blend of K1 and K2 vitamins used at nearly 10 times less than that used with vitamin K3 can provide nearly similar results to just using Vitamin K3 which by its own right is unexpectedly a very effective scorch retarding additive. Both of these compounded EPDM samples have significantly measurable improvements in scorch time based on the data below and the corresponding 150° C. Rheograph compared to the use Luperox® 101XL45 without any of these scorch retarding additives.

RPA ^{®} 2000 Rheometer Scorch data at 150° C., l deg. arc,
100 cpm frequency

| | | 9.76 phr | 9.76 phr |
|---|---|---|---|
| | | Luperox ^{®} | Luperox ^{®} |
| | 9.76 phr | 101XL45 + | 101XL45 + |
| | Luperox ^{®} | 0.013 phr | 0.12 phr |
| | 101XL45 | Super K | Vitamin K3 |
| Min S′ (ML) dN-m | 1.73 | 1.607 | 1.58 |
| Time @ 0.4 dNm scorch S′ (min) | 1.87 | 2.20 | 2.38 |
| Time @ 0.5 dNm scorch S′ (min) | 1.89 | 2.20 | 2.38 |
| Time @ 1 dNm (min) | 2.98 | 3.50 | 3.84 |
| Time @ 1.5 dNm (min) | 3.99 | 4.73 | 5.06 |
| Time @ 2 dNm (min) | 4.95 | 5.91 | 6.13 |

RPA ^{®} 2000 Rheometer Cure data at 180° C.,
1 deg. arc, 100 cpm frequency

| | | 9.76 phr | 9.76 phr |
|---|---|---|---|
| | | Luperox ^{®} | Luperox ^{®} |
| | 9.76 phr | 101XL45 + | 101XL45 + |
| | Luperox ^{®} | 0.013 phr | 0.12 phr |
| | 101XL45 | Super K | Vitamin K3 |
| Min S′ (ML) dN-m | 1.52 | 1.442 | 1.34 |
| Max S′ (MH) dN-m | 35.64 | 34.869 | 34.53 |
| Max S′-Min S′ dN-m | 34.12 | 33.426 | 33.19 |
| Time @ 0.4 dNm | 0.32 | 0.36 | 0.39 |
| scorch S′ (min) | | | |
| Time @ 0.5 dNm | 0.34 | 0.36 | 0.39 |
| scorch S′ (min) | | | |
| Time @ 1 dNm (min) | 0.41 | 0.43 | 0.46 |
| Time @ 1.5 dNm (min) | 0.46 | 0.50 | 0.52 |
| Time @ 2 dNm (min) | 0.52 | 0.56 | 0.57 |
| Time @ 50% cure (min) | 2.21 | 2.40 | 2.26 |
| Time @ 90% cure (min) | 6.63 | 6.90 | 6.68 |

1. An organic peroxide formulation comprising:
at least one organic peroxide, and
at least one natural or naturally derivable scorch retardant additive.

2. The organic peroxide formulation of claim 1, wherein the at least one natural or naturally derivable scorch retardant additive is extractable from at least one of the group consisting of thyme, cannabis, kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, and amino acids.

3. The organic peroxide formulation of claim 1, wherein the at least one natural or naturally derivable scorch retardant additive is selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, myrcene, cannabidiol, thymol, cystine, cysteine, homocysteine, methionine, taurine, N-formyl methionine, and mixtures thereof.

4. The organic peroxide formulation of claim 1, wherein the at least one natural or naturally derivable scorch retardant additive is selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, and mixtures thereof.

5. The organic peroxide formulation of claim 1, wherein the at least one natural or naturally derivable scorch retardant additive is selected from the group consisting of thymol, oleuropein, myrcene, cannabidiol, cystine, cysteine and mixtures thereof.

6. The organic peroxide formulation of claim 1 further comprising at least one crosslinking coagent comprising a moiety having at least two functional groups, wherein said functional groups are selected from the groups consisting of allylic, methacrylic, acrylic, maleimide, vinyl, and may be the same or different.

7. The organic peroxide formulation of claim 1, wherein the at least one peroxide comprises at least one selected from the group consisting of diacyl peroxides (excluding dibenzoyl peroxide); dialkyl peroxides; diperoxyketal peroxides, hemi-perketal peroxides; monoperoxycarbonates; cyclic ketone peroxides; peroxyesters; and peroxydicarbonates.

8. A method for manufacturing the organic peroxide formulation of claim 1 comprising mixing the at least one organic peroxide, and the at least one natural or naturally derivable scorch retardant additive.

9. A polymer composition comprising:
at least one polymer,
at least one organic peroxide, and
at least one natural or naturally derivable scorch retardant additive.

10. The polymer composition of claim 9, wherein the at least one natural or naturally derivable scorch retardant additive is extractable from at least one of the group consisting of thyme, cannabis, kale, collard greens, spinach, rhubarb, Chinese rhubarb, lichen, aloe vera, olive tree leaves, wintergreen, nigella sativa L. seeds or oil, henna plant leaves, red clover, alfalfa, cinchona tree bark, echinacea roots, and amino acids.

11. The polymer composition of claim 9, wherein the at least one natural or naturally derivable scorch retardant additive is selected from the group consisting of thymol, myrcene, cannabidiol, Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, emodin (6-methyl-1,3,8-trihydroxyanthraquinone), parietin or physcion (1,8-dihydroxy-3-methoxy-6-methyl-anthracene-9,10-dione), rhein (4,5-dihydroxy-9,10-dioxoanthracene-2-carboxylic acid), aloe-emodin (1,8-dihydroxy-3-(hydroxymethyl)anthraquinone), chrysophanol (1,8-dihydroxy-3-methyl-9,10-anthraquinone), chimaphilin (2,7-dimethyl-1,4-naphthoquinone), thymoquinone, dithymoquinone, thymolhydroquinone, 2-hydroxy-2,4-napthoquinone, caffeoquinone (caffeic acid quinone), chlorogenic acid quinone, olive leaf oil (oleuropein), quinine, caffeic acid, chlorogenic acid, cystine, cysteine, homocysteine, methionine, taurine, N-formyl methionine, and mixtures thereof.

12. The polymer composition of claim 9, wherein the at least one natural or naturally derivable scorch retardant additive is selected from the group consisting of Vitamin K1 (phytonadione or phylloquinone), Vitamin K2 (menaquinone), Vitamin K3 (menadione), Vitamin K2 MK-4 (menatetrenone), Vitamin K2 MK-7 (menaquinone-7), Vitamin K2 MK-14 (menaquinone 14), Vitamin K2 menatetrenone epoxide, and mixtures thereof.

13. The polymer composition of claim 9, wherein the at least one natural or naturally derivable scorch retardant additive is selected from the group consisting of thymol, oleuropein, myrcene, cannabidiol, cystine, cysteine and mixtures thereof.

14. The polymer composition of claim 9, further comprising at least one crosslinking coagent comprising a moiety having at least two functional groups, wherein said functional groups are selected from the groups consisting of allylic, methacrylic, acrylic, maleimide, vinyl, and may be the same or different.

15. The polymer composition of claim 9, wherein the at least one peroxide comprises one or more of a dialkyl, peroxyketal, hemi-perketal, peroxyester, or monoperoxycarbonate type peroxide.

16. The polymer composition of claim 9, wherein the at least one polymer is selected from the group consisting of polyethylene homopolymers, copolymers and terpolymers; chlorinated polyethylene; chlorosulfonated polyethylene, poly(ethylene vinylacetate); ethylene vinyltrimethoxysilane copolymer; ethylene propylene diene elastomers (EPDM); ethylene propylene elastomers (EPM); polyimide homopolymers, copolymers, terpolymers; bio-polyesters and copolymers; polylactic acid (PLA), poly(L-lactide-co-D,L-lactide), polyglycolic acid (PGA), poly-ε-caprolactone (PCL), polyhydroxybutyrate (PHB), and poly(3-hydroxy valerate); cellophane; cellulose esters, cellulose acetate; hydrogenated nitrile rubber (HNBR); carboxylated nitrile butadiene rubber (XNBR); acrylonitrile butadiene rubber (NBR); styrene butadiene rubber (SBR);
styrene butadiene styrene block copolymer (SBS); anionic polymerized in solution styrene butadiene styrene block copolymer (SSBR); bromobutyl rubber (BIIR); chlorobutyl rubber (CIIR); polychloroprene; natural rubber; cis-polyisoprene; polybutadiene rubber (BR); high vinyl polybutadiene rubber (HVBR); acrylated terminated and/or functionalized polybutadiene; methyl silicone rubber (MQ); vinyl methyl silicone rubber (VMQ); phenyl methyl silicone rubber (PMQ); fluorosilicone rubber (FVMQ); FKM fluoroelastomers; perfluoroelastomers (FFKM); poly(ethylene (meth)acrylate) copolymers; poly(ethylene (meth)acrylate) terpolymers; polyacrylic rubber (ACM); and poly(ethylene acrylic acid) EAA; and mixtures thereof.

17. A process for curing a polymer composition, said process comprising:
curing a polymer composition,
wherein the polymer composition comprises at least one polymer, at least one organic peroxide, and at least one natural or naturally derivable scorch retardant additive.

18. A polymeric article manufactured according to the process of claim 17.
